(19) United States
(12) Patent Application Publication
(10) Pub. No.: US 2026/0290058 A1
(43) Pub. Date: Sep. 24, 2026

(54) UNSUPERVISED TEXT REGION IDENTIFICATION

(71) Applicant: OPEN TEXT HOLDINGS, INC., Menlo Park, CA (US)

(72) Inventor: Avishek Kumar Shaw, Baidyabati (IN)

(21) Appl. No.: 19/085,706

(22) Filed: Mar. 20, 2025

(51) Int. Cl. G06V 30/146; G06V 30/18

(52) U.S. Cl. CPC G06V 30/147; G06V 30/18038

(57) ABSTRACT

Systems and methods for text localization are provided. Various embodiments of the present technology provide systems and methods for an improved and unsupervised system and method for identifying regions of interest containing text within digital documents and images. The systems and methods address the challenges of accurate text localization by employing a unique process that combines a connected component algorithm with a kernel identification algorithm. This approach allows for the processing of various input formats, including single lines, paragraphs, and full pages, overcoming the limitations of prior art systems that often require line segmentation.

### TECHNICAL FIELD

This disclosure relates generally to text region identification. In particular, this disclosure relates to systems and methods for identifying and isolating words or regions of interest in images. Even more specifically, this disclosure relates to an improved algorithm for localizing text in images, including handwritten text, machine printed text, different languages, and text with varied orientations.

### BACKGROUND

When performing some functions, for example, optical character recognition (OCR), one goal is to extract meaningful information from an image that contains text. Text recognition in documents has numerous practical applications, and researchers worldwide are attempting to develop different algorithms to enhance its accuracy. Before the character recognition takes place, the OCR system should locate where the text is in the image. This process may involve identifying the bounding boxes or regions that encompass the text elements, such as words, sentences, paragraphs, or other items containing text. Text localization, in the context of OCR, refers to the process of identifying the regions in an image or document where text is present.

Typically, a person can efficiently localize the different regions of interest (e.g., words) in a document/image containing text. However, the adaptation of such competency into an algorithm induces formidable challenges. Conventional systems for text localization typically employ machine learning (ML) models or deep learning algorithms that require extensive training and retraining. Furthermore, many systems designed for handwritten text need to be trained separately for different sources of text, styles of writing, or different individuals. Typical systems may also be limited to processing one line of text at a time, which makes it difficult to correctly identify lines of text, especially when lines overlap or are written at different orientations.

Therefore, there is a need for robust text identification algorithms that can improve the accuracy of text recognition systems used for various applications, including converting documents into searchable formats and automating data extraction from invoices and cheques for accounting purposes.

### SUMMARY

Systems and methods for text localization are described that, in some embodiments, include receiving an input image document containing textual information, identifying regions of interest on the input image document indicating locations on the image document where text may be present using a connected component algorithm, identify a potential kernel for each identified region of interest, applying the identified potential kernels to convert the input image to a binary image, identifying spaces among the regions of interest to determine gaps between potential words in the regions of interest based on the binary image, and identifying text in the input image document based on the determined gaps between potential words in the regions of interest.

Embodiments of the present invention also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 shows an example of an input image comprising three lines of handwritten text.

FIG. 2 shows an example of an input image comprising a paragraph of handwritten text.

FIGS. 3-5 show examples of input images, each comprising a line of handwritten text.

FIG. 6 shows an example of an input image comprising a paragraph of machine printed text.

FIG. 7 is a block diagram of an exemplary text region identification algorithm.

FIG. 8 is a diagram illustrating a pre-processing process.

FIG. 9 is a diagram illustrating a binary image generation.

FIG. 10 is a diagram illustrating an output generation from a binary image.

FIGS. 11-13 show examples illustrating the superior performance of the disclosed algorithms over conventional ML based systems.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The present disclosure describes a system and method that provides improved text localization algorithms that will help in enhancing the efficiency of text identification algorithms used for recognizing text in scanned documents prior to performing OCR, or other related applications performed on scanned images. For example, it may be desired to use such text identification algorithms for recognizing text in scanned documents, converting documents into searchable formats, automating data extraction from scanned documents such as invoices, cheques, etc., or numerous other applications. In addition to providing improved inputs to OCR engines, the disclosed text region identification algorithm can be used for other purposes. For example, the text region identification algorithm can be used to extract words from handwritten documents to generate training data for training OCR systems comprising deep learning algorithms. Numerous other applications are also possible, as one skilled in the art would understand. Embodiments relating to improved text localization algorithms may be better understood with reference to the following commonly-owned U.S. patent application Ser. No. 18/733,591, entitled “ KEY-POINT BASED TEXT REGION IDENTIFICATION ” by Avishek Kumar Shaw, filed on Jun. 4, 2024, which is incorporated herein by reference in its entirety for all purposes.

Generally, as described in detail below, a novel system and method is disclosed for unsupervised text region identification in digital documents and images, which represents a significant improvement over existing text localization techniques that processed text, for example, on a single-line basis. This disclosure relates to the field of text region identification, and more particularly to systems and methods for efficiently identifying and isolating words or regions of interest containing text in images. Text region identification information can be used to crop words from a document, for example, to be provided to a text recognition algorithm for prediction. One novelty of some embodiments of the disclosed system relates to the utilization of a combination of a connected component algorithm and a kernel identification algorithm to extract regions of interest in a document. This inventive process involves a process that uses a connected component algorithm to identify regions of interest, then employs a kernel identification algorithm to identify a potential kernel for each region and then identifies the space between adjacent words and/or letter. This approach overcomes some limitations of traditional systems by accepting various inputs such as paragraphs and full pages, thereby eliminating the need for prior line segmentation and offering greater versatility. One utility of the disclosed efficient word and region of interest extraction is that it improves the performance of word recognition algorithms, aids in generating data to train OCR based Deep Learning algorithms and enhances the performance of NextGen OCR algorithms. By accurately localizing text regions in a variety of document types and layouts, the disclosed algorithms provide a more robust foundation for subsequent text recognition and data extraction processes.

Before describing in detail, the unsupervised text region identification algorithms disclosed herein, following are several examples of input images containing text, and a resulting output of the algorithm, including text localized by the algorithm.

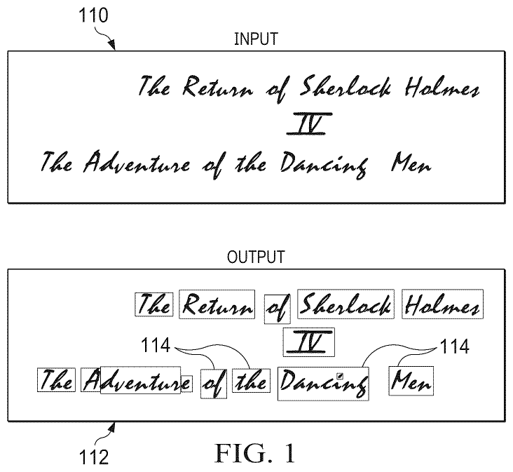

FIG. 1 shows an example of an input image 110 comprising three lines of handwritten text, including words and roman numerals. FIG. 1 also shows an algorithm output 112. As shown in the output 112, and as described in more detail below, the text region identification algorithm identifies items (e.g., words, numbers, letters, punctuation, etc.) in the input image 110, and generates bounding boxes 114 around all of the identified items present in the input image 110, including words, letters, dots, punctation, etc. In the example, of FIG. 1, bounding boxes 114 are shown around each word of the text. Note that, for clarity, only a few of the bounding boxes are identified by numeral 114 in the figures.

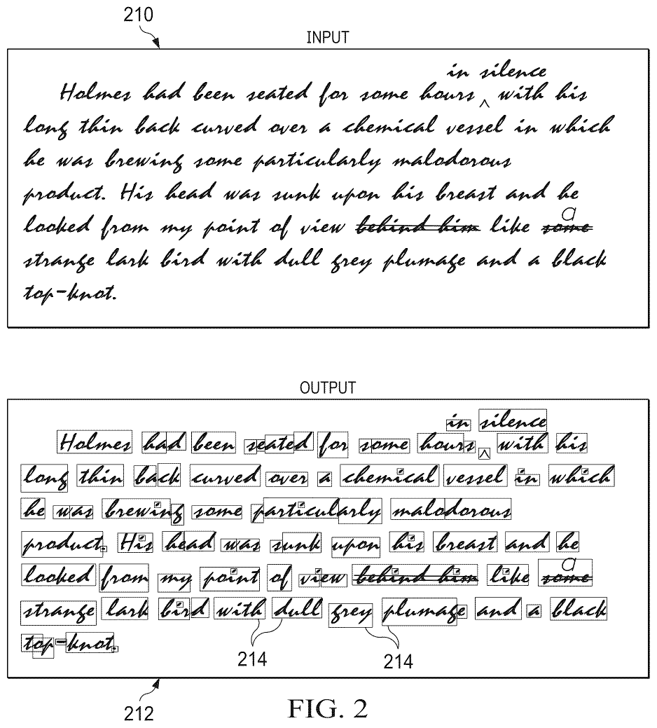

Similarly, FIG. 2 shows an example of an input image 210 comprising a paragraph of handwritten text, including words and roman numerals, as well as an edit in the first line. FIG. 2 also shows an algorithm output 212. As shown in the output 212, the text region identification algorithm identifies items (e.g., words, numbers, letters, punctuation, etc.) in the input image 210, and generates bounding boxes 214 around all of the identified items present in the input image 210.

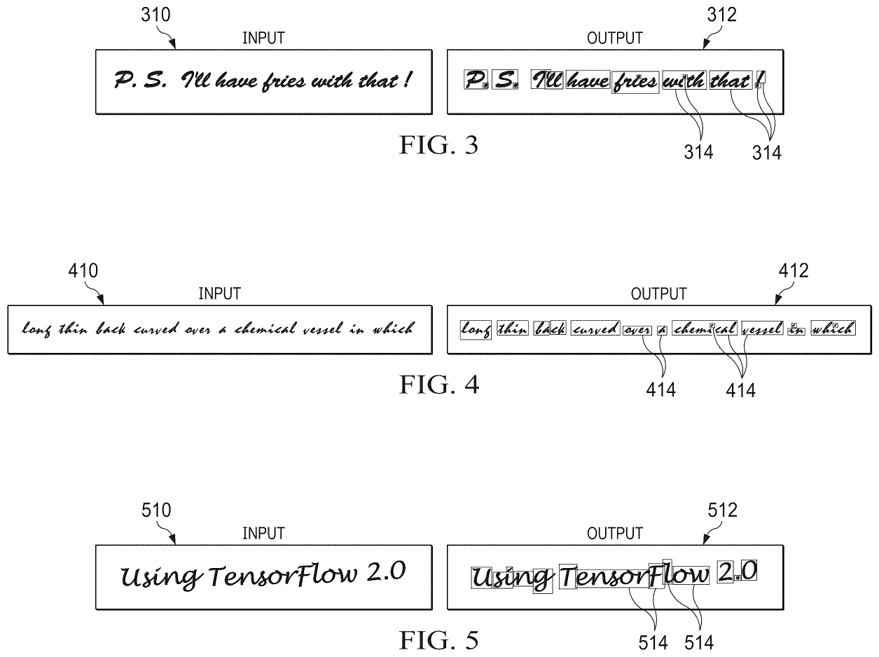

FIGS. 3-5 show examples of input images (310, 410, 510) comprising a line of handwritten text, including words, numbers, and punctuation. FIGS. 3-5 each also show an algorithm output (312, 412, 512). As shown in each output (312, 412, 512), the text region identification algorithm identifies items in each input image (310, 410, 510), and generates bounding boxes (314, 414, 514) around all of the identified items present in the input images (310, 410, 510).

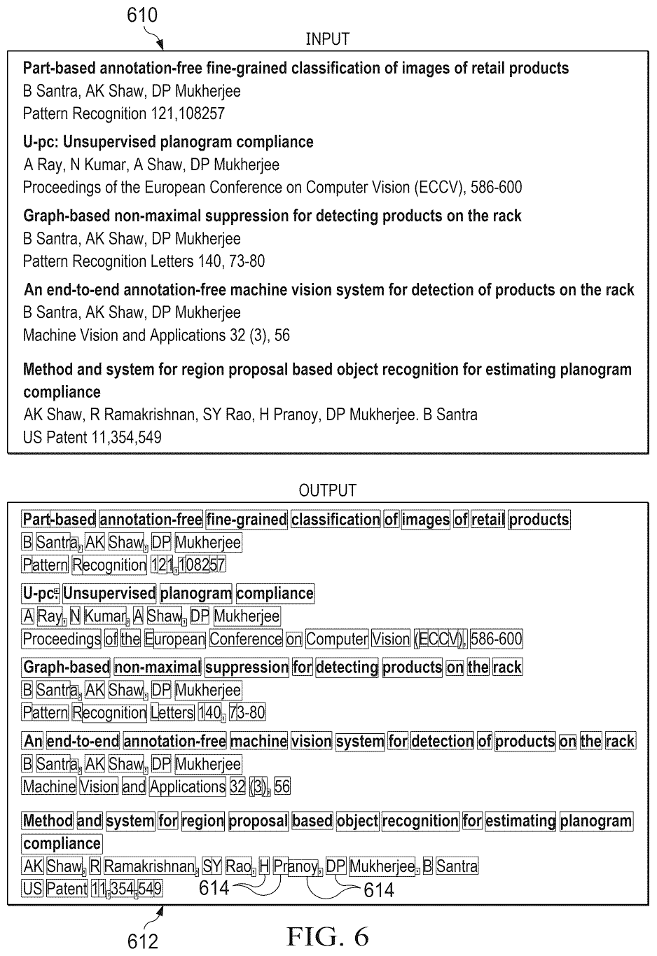

FIG. 6 shows an example of an input image 610 comprising a paragraph of machine printed text, including words, numbers, and punctuation. FIG. 6 also shows an algorithm output 612. As shown in the output 612, as with the handwritten text, the text region identification algorithm identifies items (e.g., words, numbers, letters, punctuation, etc.) in the input image 610, and generates bounding boxes 614 around all of the identified items present in the input image 610.

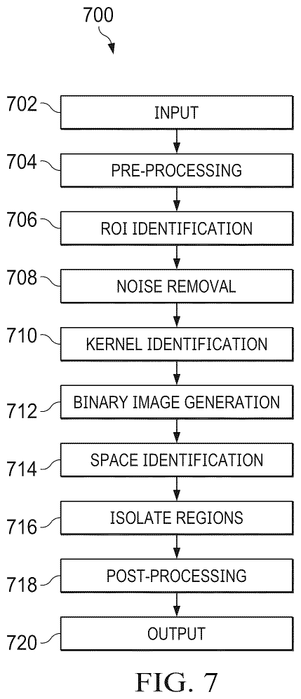

FIG. 7 is a block diagram of an exemplary text region identification algorithm 700. Generally, an input image is provided to the algorithm as an input (for example, input images (110, 210, 310, 410, 510, 610) shown in FIGS. 1-6), and the algorithm generates an output (e.g., words, characters, numbers, punctuation, etc., identified via bounding boxes, such as the bounding boxes (114, 214, 314, 414, 514, 614) shown in FIGS. 1-6). As shown in FIG. 7, an input 702 is provided to the text region identification algorithm. In some embodiments, the pre-processing step 704 (described in more detail below) converts the input image to a gray-scale image and applies a Gaussian filter to remove background noise or other information.

After the pre-processing step 704, regions of interest (ROI) are identified (step 706) to identify potential regions containing words using a connected component algorithm. For example, potential regions of interest where words could exist can be identified using a connected component algorithm (a computer vision and image processing technique).

Based on the areas identified by the connected component algorithm, noise removal step 708 filters the identified potential regions. Kernel identification step 710 is then used to identify a potential kernel for each of the potential regions. The kernel identification involves a process of detecting parts of text regions within the input image. Kernel identification helps to localize words or characters accurately.

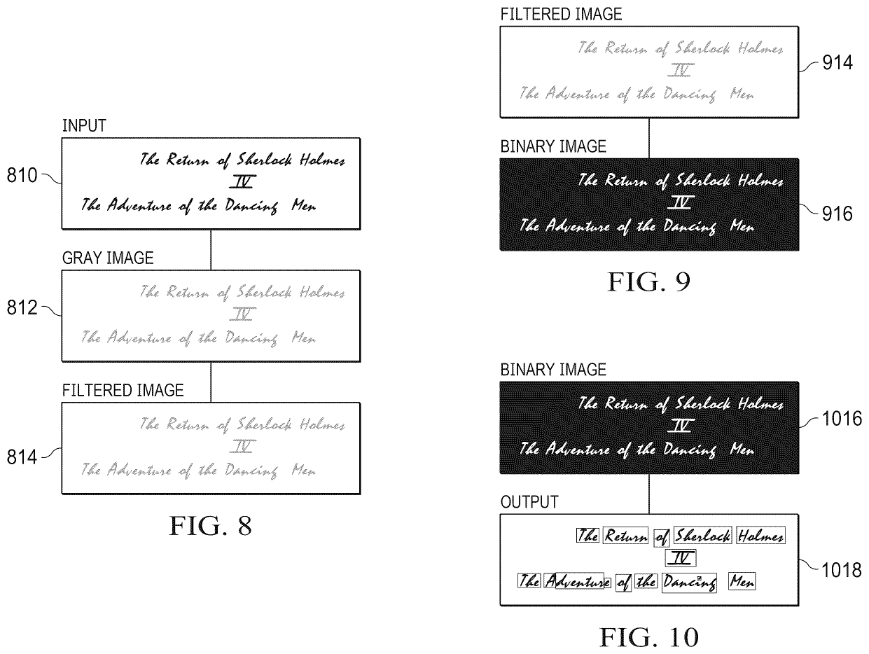

FIG. 8 is a diagram illustrating a pre-processing process that relates to the ROI identification 706, noise removal 708, and kernel identification 710, described above. FIG. 8 shows an input image 810, which in this example, is the same input image 110 shown in FIG. 1. As shown in FIG. 8, the input image 810 is converted to a gray-scale image 812. A Gaussian filter is applied to the gray-scale image 812 for noise removal, resulting in filtered image 814.

After the kernel identification step 710, a binary image generation step 712 applies the identified kernel and generates a binary image. FIG. 9 is a diagram illustrating the binary image generation. As shown, a binary image 916 is generated from the filtered image 914 (from the output of the process of FIG. 8) by applying the identified kernel to the filtered image. The binary image 916 facilitates the identification of spaces or gaps between potential words or text.

After the binary image generation step 712, space identification step 714 identifies potential spaces or gaps between two potential words or text. From the spaces identified by the space identification step 714, regions are isolated (step 716). The regions are isolated using potential rectangles (as determined by the previous steps) and potential spaces (as determined by the space identification step 714). FIG. 10 is a diagram illustrating the output 1018 generation from the binary image 1016.

A subsequent post-processing step 718 concatenates identified regions based on intersections of rectangles and results in output 720 (e.g., see outputs (112, 212, 312, 412, 512, 612) in FIGS. 1-6).

One advantage of the disclosed text region identification algorithm over conventional systems is that the disclosed text region identification algorithm does not require training. As discussed above, with a typical OCR or text identification system, machine learning models or deep learning algorithms are used, which require extensive training and re-training. While the disclosed text region identification algorithm can be used to improve such systems, the text region identification algorithm itself does not require training. In addition, with many typical conventional systems designed for handwritten text, the systems may need to be trained separately for different sources of text, different styles of writing, or for different people. In contrast, the disclosed text region identification algorithm does not need to be trained or configured separately for different sources of text. As discussed in detail above, the disclosed text region identification algorithm extracts words (or a region of interest) from handwritten text without the need for extensive training and re-training or using complicated ML systems will make a resulting system operate in a more efficient and timely manner, since resources do not need to be dedicated to vast input and training data, complicated ML systems, etc.

The text region identification algorithm such as that illustrated in FIG. 7 provides a significant improvement over conventional systems. For example, docTR Document Text Recognition is a popular OCR tool using a two-stage approach-text detection (localization), and then text recognition. While docTR works well for machine generated text, the disclosed text region identification algorithm provides a significant improvement when used on handwritten text.

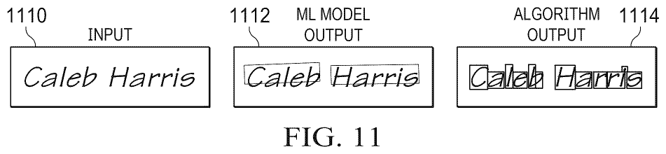

FIGS. 11-13 show examples illustrating the superior performance of the disclosed algorithms over conventional ML based systems. FIG. 11 shows an input image 1110 comprising one line of handwritten text. A ML model output 1112 is an actual output from a conventional system, while algorithm output 1114 shows the output from the disclosed text region identification algorithm (e.g., FIG. 7). As shown, the accuracy of the output 1114 is superior to that of ML model output 1112, all while using less computing resources, operating faster, and working without complicated and expensive training.

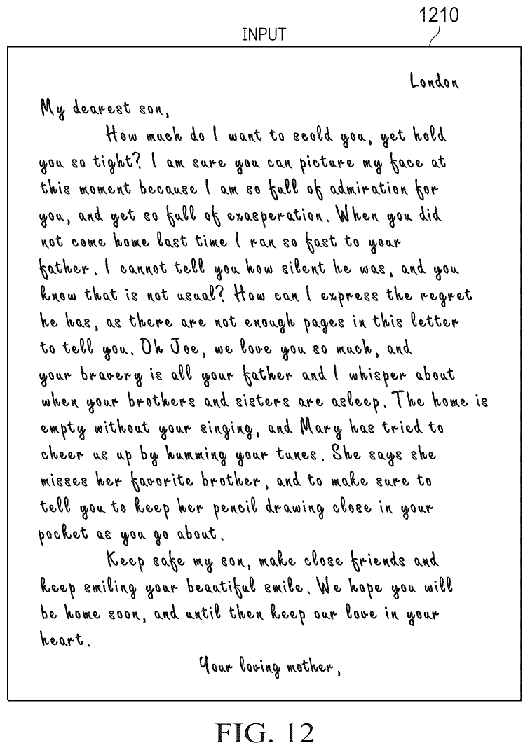

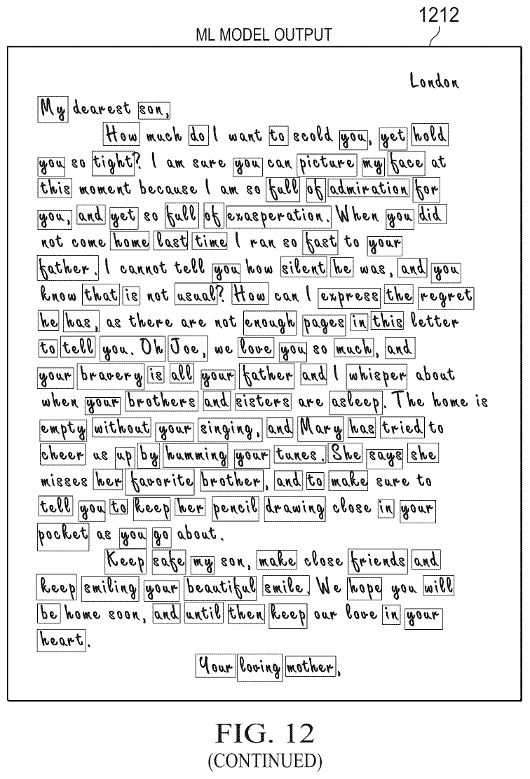

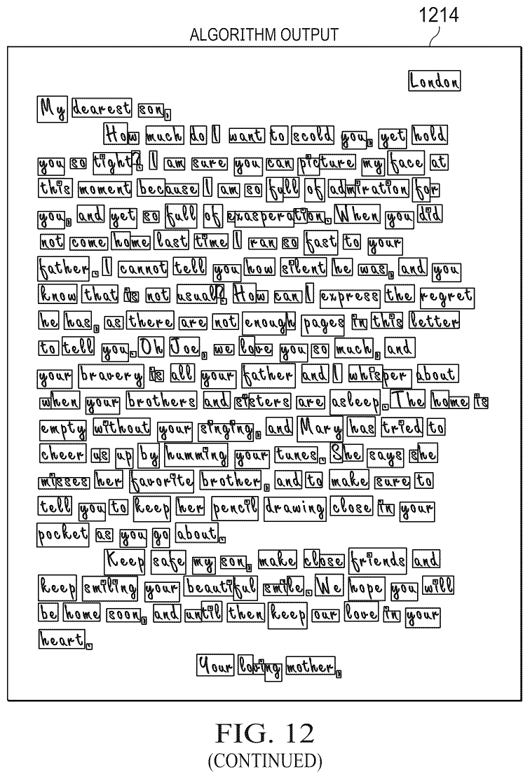

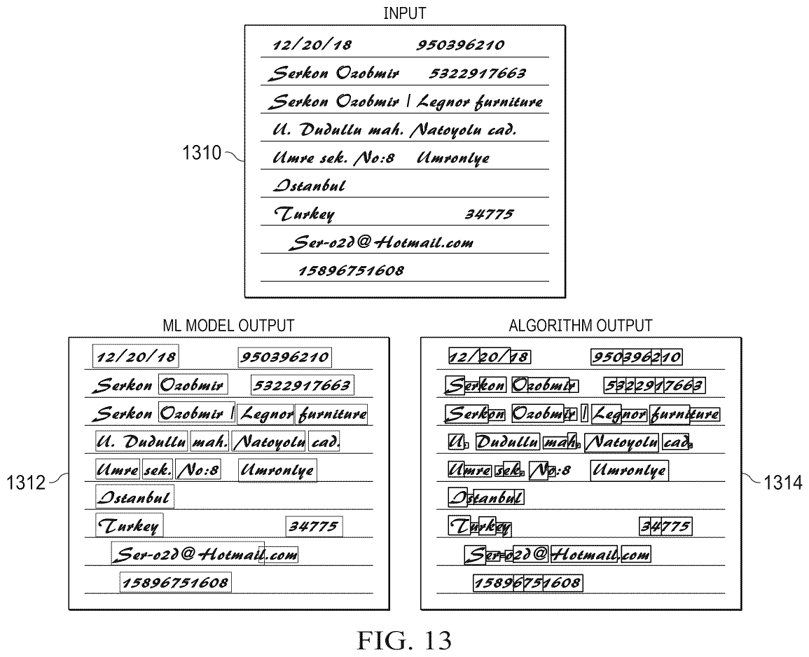

FIG. 12 shows an input image 1210 comprising a handwritten letter from a mother to her son. A ML model output 1212 is also an actual output from a conventional system, while algorithm output 1214 shows the output from the disclosed text region identification algorithm (e.g., FIG. 7). As shown, the accuracy of the output 1214 is superior to that of ML model output 1212. The ML model output 1212 missed numerous words, while algorithm output 1214 did not.

FIG. 13 shows an input image 1310 comprising a hand note card having pre-printed lines. A ML model output 1312 is also an actual output from a conventional system, while algorithm output 1314 shows the output from the disclosed text region identification algorithm (e.g., FIG. 7). As shown, the accuracy of the output 1314 is superior to that of ML model output 1312. The ML model output 1312 missed several words, perhaps due to the lines on the card.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method of text localization, comprising:
receiving an input image document containing textual information;
identifying regions of interest on the input image document indicating locations on the image document where text may be present using a connected component algorithm;
identify a potential kernel for each identified region of interest;
applying the identified potential kernels to convert the input image to a binary image;
identifying spaces among the regions of interest to determine gaps between potential words in the regions of interest based on the binary image; and
identifying text in the input image document based on the determined gaps between potential words in the regions of interest.

2. The method of claim 1, further comprising converting the input image document to a gray-scale image prior to converting the image to a binary image.

3. The method of claim 2, further comprising filtering the gray-scale image prior to converting the image to a binary image.

4. The method of claim 3, wherein filtering the gray-scale image further comprises applying a Gaussian filter.

5. The method of claim 1, wherein the textual information comprises handwritten text.

6. The method of claim 1, wherein the textual information comprises machine printed text.

7. A system for providing text localization, the system comprising:
a processor; and
a non-transitory computer readable medium storing instructions translatable by the processor, the instructions when translated by the processor perform:
receiving an input image document containing textual information;
identifying regions of interest on the input image document indicating locations on the image document where text may be present using a connected component algorithm;
identify a potential kernel for each identified region of interest;
applying the identified potential kernels to convert the input image to a binary image;
identifying spaces among the regions of interest to determine gaps between potential words in the regions of interest based on the binary image; and
identifying text in the input image document based on the determined gaps between potential words in the regions of interest.

8. The system of claim 7, further comprising converting the input image document to a gray-scale image prior to converting the image to a binary image.

9. The system of claim 8, further comprising filtering the gray-scale image prior to converting the image to a binary image.

10. The system of claim 9, wherein filtering the gray-scale image further comprises applying a Gaussian filter.

11. The system of claim 7, wherein the textual information comprises handwritten text.

12. The system of claim 7, wherein the textual information comprises machine printed text.

13. A computer program product comprising a non-transitory computer readable medium storing instructions translatable by a processor, the instructions when translated by the processor perform, in an enterprise computing network environment:
receiving an input image document containing textual information;
identifying regions of interest on the input image document indicating locations on the image document where text may be present using a connected component algorithm;
identify a potential kernel for each identified region of interest;
applying the identified potential kernels to convert the input image to a binary image;
identifying spaces among the regions of interest to determine gaps between potential words in the regions of interest based on the binary image; and
identifying text in the input image document based on the determined gaps between potential words in the regions of interest.

14. The computer program product of claim 13, further comprising converting the input image document to a gray-scale image prior to converting the image to a binary image.

15. The computer program product of claim 14, further comprising filtering the gray-scale image prior to converting the image to a binary image.

16. The computer program product of claim 15, wherein filtering the gray-scale image further comprises applying a Gaussian filter.

17. The computer program product of claim 13, wherein the textual information comprises handwritten text.

18. The computer program product of claim 13, wherein the textual information comprises machine printed text.
